(19) United States
(12) Patent Application Publication
(10) Pub. No.: US 2017/0221281 A1
(43) Pub. Date: Aug. 3, 2017

(54) METHOD FOR DETERMINING THE DUTY FACTOR OF A PULSE-WIDTH-MODULATED SIGNAL AND VEHICLE CONTROL UNIT

(71) Applicant: WABCO GmbH, Hannover (DE)

(72) Inventors: Christian HECHT, Wunstorf (DE); Henning SÜLTMANN, Hannover (DE)

(21) Appl. No.: 15/501,551

(22) PCT Filed: Jul. 13, 2015
(86) PCT No.: PCT/EP2015/001435

§ 371 Date: Feb. 3, 2017

(30) Foreign Application Priority Data
Aug. 5, 2014 (DE) 10 2014 011 706.5

(51) Int. Cl. G07C 5/08; B60T 17/22

(52) U.S. Cl. CPC G07C 5/08; B60T 17/22

(57) ABSTRACT

The present invention provides a method for the redundant measurement of the duty factor of pulse-with-modulated signals 12 via a vehicle control unit. According to the method, a direct determination of the duty factor of the signal 12 is performed by way of periodic sampling.

### CROSS-REFERENCE TO RELATED APPLICATIONS

This application is the National Stage of International Application No. PCT/EP2015/001435, filed on 13 Jul. 2015, which claims priority to and all advantages of German Patent Application No. 10 2014 011 706.4, filed on 5 Aug. 2014, the content of which is hereby incorporated by reference.

### FIELD OF THE INVENTION

The invention generally relates to a method for determining the duty factor of a signal and, more specifically, to a method for determining the duty factor of a pulse-width-modulated signal via a vehicle control unit and to the vehicle control unit.

### BACKGROUND OF THE INVENTION

Vehicle control units are used for controlling and monitoring individual or multiple functions of a vehicle, in particular of a motor vehicle. In this case, external signals or measured values are generally processed, which therefore must be recorded or gathered by the control unit. This measured value recording or detection of the signals as well as the processing thereof usually must meet high safety requirements in order to preferably avoid malfunctions. The requirements vary depending on the use and function of the vehicle control unit.

Brake control units are vehicle control units which generally must meet particularly high safety requirements. For example, various brake control units are used within the scope of a modular brake system platform, in particular electronically controlled brake systems or special antilock brake systems.

A braking demand is typically the most important external signal in this case. This is generally specified by the driver of the vehicle, wherein the actuation of a brake pedal is usually evaluated. For this purpose, the brake pedal generally comprises two independent measurement transmitters, i.e., so-called brake signal transmitters. When the pedal is actuated, a pulse-width-modulated (or pulse-length-modulated) signal (PWM signal) is generated by each of the brake signal transmitters. The duty factor, i.e., the ratio of the duration of two states relative to each other, is dependent on the actuation, in particular on the position of the brake pedal. The duty factor is therefore typically proportional to the intensity of the step onto the brake pedal, i.e., in particular on its travel.

For safety reasons, not only are two independent brake signal transmitters utilized, but the detection or measurement of the duty factor of the signal also takes place in a redundant way. For this purpose, the duty factor of the signal is usually initially determined via a first (main) method. This typically takes place via a so-called capture/compare unit (CCU) which is integrated in many microcontrollers. The vehicle control units or brake control units discussed herein also comprise such microcontrollers having at least one capture/compare unit. This then determines the duty factor of the pulse-width-modulated signal through time measurement. In addition, in further consecutive measurements, it can be established whether the value of the duty factor changes and at what speed this takes place.

In order to permit control of the determination of the duty factor, the signal is additionally filtered via a low-pass filter and is fed to an analog-digital converter (A/D converter). The result also corresponds to the duty factor of the pulse-width-modulated signal and can therefore be used for monitoring the recording of measured values by the CCU. Low-pass filters and analog-digital converters are installed on at least one printed circuit board in addition to the microcontroller.

The disadvantage of the known method for the redundant recording of the duty factor is that external components, in addition to the microcontroller, are required for this purpose, namely at least one low-pass filter and one or multiple A/D converters. These take up space on the printed circuit board, result in additional costs, and must be installed. In addition, the analog-digital conversion or the low-pass filtering results in undesirable delays.

### SUMMARY OF THE INVENTION

The present invention provides a method for the redundant determination of the duty factor of a pulse-width-modulated signal via a vehicle control module which allows for a determination of the duty factor, whereby space is saved on the printed circuit board and without external components being required therefor.

According to the method, the signal is periodically sampled or scanned by the vehicle control unit in order to determine the duty factor. It is used, in particular, for the redundant determination of the duty factor in addition to a further measuring method. This means that the duty factor is determined from a regular measurement of the signal. The periodic scan can take place by existing components in the vehicle control unit, in particular directly by an existing microcontroller. For this purpose, the signal is scanned or processed, preferably by existing units in the microcontroller, via an existing input of the microcontroller. The method is preferably independent of the recording of measured values by the capture/compare unit (CCU). Additional components, such as, for example, a low-pass filter, are therefore not required according to the invention. Delays caused by the analog-digital conversion or the low-pass filtering are therefore avoided.

In certain embodiments, the signal has multiple, for example two, possible states. The states are assumed one after the other, in particular. Typically, each of the states is assumed only once within one cycle. Therefore, the duration of the cycle can be determined.

The ratio of the time duration of the states generally represents the duty cycle of the signal. Therefore, the duty factor results, in particular, from the ratio of the time durations of the states relative to each other.

The length of one, preferably each state of the signal, may be determined by counting the clock pulses of the clock signal in the particular state. In certain embodiments, a duty factor of the signal is determined and/or calculated from the ratio of the duration of multiple states of the signal.

More specifically, in certain embodiments, at least one complete cycle of the signal is measured. One cycle of the signal consists, in particular, of one pass through both states. The duty factor is then determined and/or calculated from the ratio of the duration of the two states.

The signal may be scanned or sampled in fixed intervals or at a constant frequency. This means that a regular recording of measured values or a scanning of the signal takes place. The time difference between two measurements is typically determined in advance. Therefore, the temporal course of the state of the pulse-width-modulated signal can be established in a reproducible way.

Further, in certain embodiments, a periodic clock signal is generated and/or used in order to periodically scan or sample the signal. Therefore, the periodic query is coupled in a simplified way to periodic clock signals, which are available in large numbers.

In particular, the scan or the sampling can take place during every single clock event and/or after an established number of clock events or clock intervals or clock cycles.

The clock signal generally has a constant clock rate. This means that the clock events occur with a constant frequency and, therefore, in a well-reproducible manner.

In certain embodiments, the clock intervals are constant or are equally long. This means that the clock events occur in a regular sequence. The clock cycles, i.e., the spacing between two clock events, are therefore typically also equally long. Alternatively, however, two superimposed clock cycles can be used, for example. For this purpose, generally more than one single clock signal can be used, however, in order to thereby be able to make a distinction.

The clock signal typically has a higher clock rate or modulation frequency than the signal. Due to a sufficiently high clock rate, it is ensured that the signal can be sampled with sufficient frequency. In this way, the signal can preferably be provided with a sufficiently high resolution. Errors in the measurement of the state duration are thereby minimized. This is helpful, in particular, in order to be able to determine the length of the pulse width of the signal as precisely as possible.

In various embodiments, the clock rate or the sampling rate is higher—by at least approximately one order of magnitude, preferably two orders of magnitude—in the case of the clock signal than in the case of the signal. One order of magnitude corresponds to a factor of 10, as understood in the art. This ensures a sufficiently high sampling rate.

Typically, the duty factor of the states of the signal depends on the actuation of the at least one sensor. Therefore, a sensor actuation is converted into such a signal.

In certain embodiments, the travel or the extent and/or the speed of the actuation is decisive for the duty factor of the states. Preferably, the duty factor is proportional to the intensity of the actuation or the travel of the sensor or of the associated measuring sensor. A brake pedal, in particular, is used as the sensor for a brake control unit.

In certain embodiments, multiple, in particular the two methods for determining the duty factor are carried out independent of each other and/or are based on different principles. This allows for a redundant determination of the duty factor in an independent way. By using different principles or measuring methods, errors which are intrinsic to any particular method can be ruled out.

For example, the frequency of the pulse-width modulation of the signal is determined from the duty cycle of the signal. Therefore, a failure of the measurement transmitter or the brake signal transmitter can be determined, respectively. This determination is made possible, in particular, by the measuring method according to the invention. For this purpose, the number of clock events for one complete cycle of the pulse-width modulation is counted and is multiplied by the duration of a single clock event. The reciprocal of this value is the frequency. This offers the advantage that a frequency determination is possible independently of other components, i.e., complete redundance. In the prior art, however, a determination generally takes place via the main method or the capture/compare unit (CCU). Therefore, a frequency determination would no longer be possible if this prior art system would fail. A determination of the duty factor is not possible in the case of analog measuring methods, either, since only one fixed voltage value is measured, but a time measurement for frequency determination is not possible.

The present invention also provides a vehicle control unit. The vehicle control unit, preferably a brake control unit, such as, for example, an ABS (antilock brake system) and/or an EBS (electronic brake system) control unit, is provided, which is designed so as to be suitable, in particular, for carrying out the above-described method. The vehicle control unit is distinguished by the fact that the recording device periodically scans or samples the state of the signal for determining the duty factor. The vehicle control unit is typically designed for the periodic scanning or the periodic sampling thereof. As a result, the duration of the possible states of the signal can be determined separately. This measuring method fundamentally differs from the usual measured value gathering or determination, for example, via an analog-digital converter or via that of a capture/compare unit (CCU). Therefore, an alternative method can be implemented in a vehicle control unit.

In certain embodiments, a device for generating and/or evaluating a periodic clock signal is provided, in order to trigger the periodic sampling of the signal. Therefore, regular scanning is ensured.

For example, an interrupt request of the vehicle control unit can be provided as a clock signal. Such interrupt requests or interrupts are implemented, in particular, in practically every microcontroller. Therefore, they are also typically provided in a vehicle control unit. They are used, for example, for scanning external units and/or components, for determining measured values at certain units of time, or the like. In this case, they are used for the periodic sampling of the signal.

In certain embodiments, the signal has multiple, typically two, states. The ratio of the duration of the states with respect to one another therefore yields a basis for calculating an actuation of the sensors. In particular, the time duration of the states relative to one another can be expressed as a ratio, and so the duty factor can therefore be calculated. The control unit is designed, in particular, for carrying out precisely this determination.

The ratio of the duration of the states or the ratio of the lengths of the states yields, in particular, a basis for calculating the actuation of the sensors, in particular with respect to the path length, the travel, the extent or the speed and/or for the acceleration of the actuation. For example, a pedal, such as, in particular, a brake pedal, can be merely tapped, stepped on to a more or less great extent, or pressed all the way down. For this purpose, the duty factor of the signal yields a corresponding measured value, in particular. The duty factor is preferably proportional to the pedal travel. There is generally a linear relationship between the pedal travel and the duty factor.

In certain embodiments, at least at least one counter is provided for the particular number of the clock pulses of a state of the signal. Therefore, the time duration of the particular state of the signal can be indirectly determined. The duty cycle, in particular, can then be calculated from the ratio of the count values of multiple states of the signal.

In these or other embodiments, a redundant scanning and/or determination of the duty factor of the signal is provided in the vehicle control unit. Therefore, an error-free scanning is ensured even in the event of failure of individual components.

In these or other embodiments, multiple independent and/or differently functioning devices or methods for determining the duty factor of the signal are provided for a redundant determination of the duty factor. Different methods or devices or units which function independently of one another ensure sufficient reliability. Errors which are intrinsic to any particular method are thereby ruled out to the greatest extent possible.

### BRIEF DESCRIPTION OF THE DRAWINGS

The invention is described in greater detail below with reference to the accompanying figure, in which:

FIG. 1 shows a vehicle control unit for the redundant determination of the duty factor of a pulse-width-modulated signal according to the prior art;

FIG. 2 shows a vehicle control unit according to the invention for the redundant determination of the duty factor, and

FIG. 3 shows one representation of a pulse-width-modulated signal having an associated clock signal.

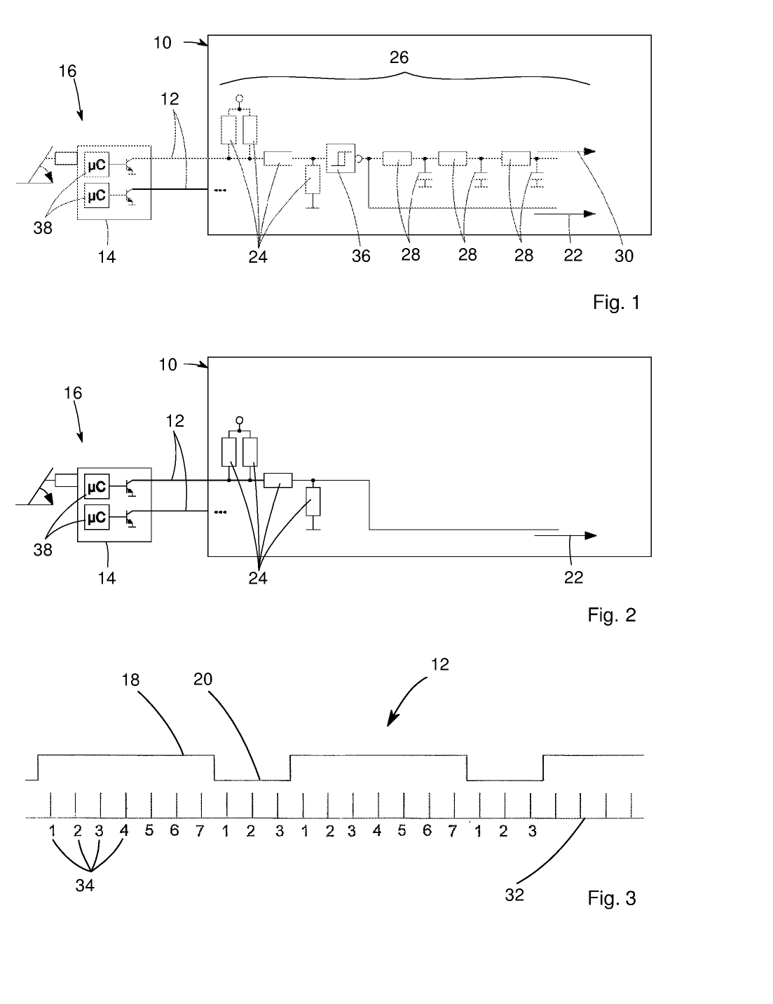

### DETAILED DESCRIPTION

The vehicle control unit of the exemplary embodiment described herein is a brake control unit 10. The brake control unit 10 is used for initiating and controlling braking operations in a vehicle which is not shown here, for example, a truck or a bus. Inter alia, the brake control unit 10 contains a microcontroller, which is not represented here. The microcontroller performs the actual measuring, control, and monitoring tasks.

In the prior art, the vehicle comprises at least one source of a signal 12, i.e., a so-called signal emitter or a signal transmitter. Two such signal transmitters are each designed as a brake signal transmitter 14 in this case. The actuation of a corresponding device, such as a brake pedal 16 in this case, yields information regarding a braking demand of a driver of the vehicle, which is not shown here and in which the brake control unit 10 operates. The brake control unit 10 comprises an input for the processing of the signal 12. As soon as a braking demand is detected, a braking operation must be initiated immediately.

Initially, for that purpose, the information regarding the actuation of the brake pedal 16 is converted via the brake signal transmitter 14 into a pulse-width-modulated signal 12. Depending on how strong the braking effect is intended to be, the driver usually varies the extent or the travel of the actuation of the brake pedal 16. This means that, when the brake pedal 16 is slightly deflected, the intention is to achieve merely a low braking effect, while a greater deflection of the brake pedal 16 indicates the intention to achieve a great braking effect. The resultant signal 12 therefore represents a value which is proportional to the actuation of the brake pedal 16.

This is achieved via a pulse-width modulation of the signal 12. In this case, two different states 18 and 20 are usually provided. The states 18 and 20 are generally two different voltage levels. The duration of the two states 18 and 20 can be varied, wherein the total duration of the two states 18 and 20, taken together, is generally constant. The ratio of the duration of the first state 18 to the duration of the second state 20 therefore yields the so-called duty factor of the signal 12.

This ratio of the two states 18 and 20 then yields, overall, a value which is proportional to the pedal actuation. Actually, for this purpose, the lengths or time durations of the two states 18 and 20 with respect to one another are expressed as a ratio. The longer the signal 12 in the state 18 is, the shorter the signal 12 in the state 20 is, since the total length or the total duration of one cycle of the pulse-width modulation is typically constant. The durations of the two states 18 and 20, which have been expressed as a ratio, therefore yield a ratio which has a value between zero and infinity, wherein usually a maximum value is set.

The signal 12 is usually transmitted via electrical and/or lines from the brake pedal 16 to the brake control unit 10. Usually, the duty factor of the signal 12 is determined there by means of a so-called capture/compare unit (CCU). Although such a CCU is not represented here, it is supplied with the signal 12 via a line 22. In this capture/compare unit, the length or duration of each of the two states 18 and 20 of the signal 12 is detected and each is stored as a count value. By comparing multiple stored values, additional information regarding the speed of the actuation of the brake signal transmitter 14 or other information regarding the dynamics of the process can be determined.

The generation of the measured values by the brake signal transmitter 14, including the actual generation of the pulse-width-modulated signal 12 by the microcontroller 38, generally takes place outside of the brake control unit 10, namely in the region of the brake pedal 16. The signal 12 is then processed in the input stage 24 of the brake control unit 10.

A redundant recording of measured values usually takes place in order to increase the reliability of the data capture in the determination of the duty factor of the pulse-width-modulated signal 12. Typically, a separate unit 26 is provided for this purpose. In the prior art, such a unit comprises a low-pass filter 28 and an analog-digital converter 30. Through the low-pass filtering and the analog-digital conversion, a value is generated, which represents the duty factor of the pulse-width-modulated signal 12. The current measured value of the capture/compare unit, which is likewise supplied with the signal 12 via the line 22, can be compared with this value at any time.

The signal 12, with its two states 18 and 20, is processed within the brake control unit 10 at any time. Therefore, it is readily possible to detect both the presence of the state 18 and the state 20. In this case, a complete cycle of the signal 12 from the combination of a state 18 and a state 20 takes place before a switch back to the state 18 takes place.

According to the invention, however, the additional components of the unit 26 are no longer required, and so the low-pass filter 28 and the analog/digital converter 30 can be dispensed with. Instead of a filtering and a recording of measured values via analog-digital converters 30, the alternative measuring or determination method according to the invention is used here. In this case, a clock signal 32 is used, as is represented in FIG. 3, by way of example. The clock signal 32 comprises a plurality of clock events 34. These occur sequentially in fixed time intervals, and are therefore (strictly) periodic.

The core of the new method for determining the duty factor is that of scanning the current state of the signal 12 in a regular way, i.e., periodically. The clock signal 32 forms the basis therefor, in order to scan the current state of the signal 12 for each clock event 34. This is likewise depicted in FIG. 3. The number of clock events 34 for each state 18 or 20 are counted for this purpose. If the signal 12 is initially in the state 18, a first counter is incremented. This is repeated for every further clock event in the state 18. As soon as the state 20 is determined for a clock event 34, a second counter is incremented. This is repeated for all further clock events 34 until, in turn, a switch into the state 18 takes place.

In the exemplary embodiment of FIG. 3 shown, seven clock events in the state 18 are counted, while only three clock events in the state 20 are determined. The imprecision of the determination is in the range of the spacing between two clock events 34, i.e., within the modulation frequency of the clock signal 32. The duty factor Tv is calculated as follows

Tv=t(state 18)/(t(state 18)+t(state 20)).

In this case, the computation is therefore Tv=7/(7+3)=0.7. A linear relationship between the pedal travel and the measured value therefore results. Due to the spacings—which are of the same length—between the clock events 34, the counted events for the states 18 and 20 therefore yield the duty factor of the signal 12. After completion of such a test cycle, the two counters are therefore rested before the next measurement cycle begins.

The determined value of the duty factor Tv can then be compared directly with the values determined by the memory and comparison unit.

A separately generated signal as well as a signal which is already present within the brake control unit 10 or another microcontroller can be used as the clock signal 32. An interrupt request or an interrupt is suitable, in particular, for this purpose. This is utilized by the microcontroller in the brake control unit 10 for query purposes or for interrupting on-going processes, for example, in order to handle parallel tasks. Such clock-pulse generators, in particular interrupts, are present in practically every microcontroller. In addition, a unit for detecting the two states 18 and 20 is already present in the control unit 16. Therefore, a method for determining the duty factor Tv of the signal 12 can be implemented via two counters and a central processing unit. By increasing the sampling frequency, i.e., by means of a higher-frequency clock signal, the accuracy of the determination of the duty factor can be increased even further, if necessary.

Finally, in this method, the additional components 26, namely the low-pass filter 28 and the analog-digital converter 30, are no longer required. The signal 12 is therefore fed directly to the capture/compare unit via the line 22, as shown in FIG. 2.

If necessary, a Schmitt trigger 36 or a similar component can also be provided, in order to pull both states 18 and 20 of the signal 12 to a defined voltage level or to adjust the impedance, in particular by way of providing a driver having low impedance.

In addition, the modulation frequency of the signal 12 or the frequency of the pulse-width modulation can be determined directly from the signal 12. The frequency of the pulse-width modulation is the repetition rate of the cycles of the signal 12, wherein one cycle of the signal 13 consists of exactly two associated states 18 and 20.

In order to determine the frequency of the pulse-width modulation, the number of clock events 34, which result in one complete cycle of the signal 12 comprising the two states 18 and 20, is counted. When the frequency of the clock signal 32 is known, the duration of one clock event 34 is also known. Therefore, the number of counted clock events 34 of one cycle of the signal 12 is multiplied by the duration of one clock event 34. This results in the period of one cycle of the signal 12. The reciprocal of this period, i.e., a division of 1 by the period, then results in the frequency of the pulse-width modulation of the signal 12. The calculation can therefore be carried out as follows:

$$\begin{matrix}Frequency = 1 / cycle time \\ = 1 / ( number\_clock events ⋆ duration\_clock event )\end{matrix}$$

The determination of the frequency of the pulse-width modulation therefore takes place independently of further external components. In this way, for example, a failure of one of the brake signal transmitters 14 or of the entire brake pedal 16 can be easily determined.

What is claimed is:

1. A method for the redundant determination of the duty factor of a pulse-width modulated signal via a vehicle control unit, wherein the signal is generated and/or provided by at least one sensor, said method comprising:
measuring time durations of a state of the signal via a capture/compare unit (CCU), and
periodically sampling the signal by the vehicle control unit in order to determine the duty factor.

2. The method as claimed in claim 1, wherein the signal comprises multiple possible states.

3. The method as claimed in claim 2, wherein a ratio of the time duration of the states represents the duty factor of the signal.

4. The method as claimed in claim 1, wherein a length of one or each state of the signal is determined by counting clock pulses of a clock signal, during which the signal is in a particular state.

5. The method as claimed in claim 1, wherein the duty factor of the signal is determined and/or calculated from a ratio of the duration of multiple states of the signal.

6. The method as claimed in claim 1, further comprising measuring at least one complete cycle of the signal.

7. The method as claimed in claim 1, further comprising regularly sampling the signal in fixed intervals or at a constant frequency.

8. The method as claimed in claim 1, further comprising generating and/or utilizing a periodic clock signal to periodically scan the signal.

9. The method as claimed in claim 8, wherein the signal is sampled during each clock event and/or every time after an established number of clock events.

10. The method as claimed in claim 1, wherein a clock signal has a constant clock rate.

11. The method as claimed in claim 10, wherein the clock intervals are constant or are equally long.

12. The method as claimed in claim 1, wherein a clock signal has a higher clock rate or modulation frequency than the signal.

13. The method as claimed in claim 12, wherein the clock signal has a clock rate or modulation frequency which is higher than the signal by at least approximately one order of magnitude.

14. The method as claimed in claim 1, wherein the duty factor of the states depends on an actuation of the sensor.

15. The method as claimed in claim 1, wherein the duty factor of the states depends on an extent and/or a speed of an actuation of the sensor.

16. The method as claimed in claim 1, wherein the steps for determining the duty factor are carried out independent of each other and/or are based on different principles.

17. The method as claimed in claim 1, further comprising determining a modulation frequency of the signal from the duty factor of the signal.

18. A vehicle control unit for carrying out the method of claim 1, said vehicle control unit comprising at least one recording device for recording at least one pulse-width-modulated signal, which is provided and/or generated by at least one sensor, wherein the recording device determines the duty factor of the signal, wherein the recording device is designed for periodically scanning a state of the signal in order to determine the duty factor of the signal.

19. The vehicle control unit as claimed in claim 18, further comprising a device for generating and/or evaluating a periodic clock signal to trigger the periodic scan of the signal.

20. The vehicle control unit as claimed in claim 18, wherein an interrupt request or an interrupt of the vehicle control unit is provided as a clock signal for triggering the periodic scan of the signal.

21. The vehicle control unit as claimed in claim 18, wherein the signal has multiple states, wherein a ratio of a duration of the states is used as a basis for calculating an actuation of the at least one sensor.

22. The vehicle control unit as claimed in claim 21, wherein the ratio of the duration of the states is used as a basis for calculating an extent and/or speed and/or acceleration of an actuation of the at least one sensor.

23. The vehicle control unit as claimed in claim 18, wherein at least one counter is provided for a particular number of clock pulses of a state of the signal.

24. The vehicle control unit as claimed in claim 18, wherein a redundant scan and/or determination of the duty factor of the signal is provided.

25. The vehicle control unit as claimed in claim 18, wherein multiple independent and/or differently functioning devices or methods for determining the duty factor of the signal are provided.

26. The vehicle control unit as claimed in claim 18, wherein a determination of a modulation frequency of the signal on the basis of the duty cycle thereof is provided.
